(19) United States
(12) Patent Application Publication
(10) Pub. No.: US 2016/0278359 A1
(43) Pub. Date: Sep. 29, 2016

(54) Fishing Rod Holder Having an Auger Device

(71) Applicant: Coastal Assault, LLC, Winter Park, FL (US)

(72) Inventor: Christian Colton, Oviedo, FL (US)

(73) Assignee: Coastal Assault, LLC, Winter Park, FL (US)

(21) Appl. No.: 15/079,945

(22) Filed: Mar. 24, 2016

Related U.S. Application Data
(60) Provisional application No. 62/138,070, filed on Mar. 25, 2015.

(51) Int. Cl. A01K 97/10

(52) U.S. Cl. CPC A01K 97/10

(57) ABSTRACT

The present disclosure provides advantageous automated fishing rod holder assemblies, and related methods of use. More particularly, the present disclosure provides improved fishing rod holder assemblies having an actuator device configured to drill a releasably mounted auger member into a desired surface to allow such rod holder assemblies to be easily mounted to the surface and later removed from the surface. The present disclosure provides for a fishing rod holder assembly including a housing extending from a first end to a second end, with an actuator device mounted with respect to the second end of the housing. An auger member can be mounted to the actuator device, with the actuator device configured to drill the auger member into a desired surface to allow the rod holder assembly to be easily mounted in a substantially upright position relative to the surface, and then later easily removed from the surface.

### CROSS-REFERENCE TO RELATED APPLICATIONS

This application claims the benefit of U.S. Provisional Application No. 62/138,070 filed Mar. 25, 2015, all of which is herein incorporated by reference in its entirety.

### FIELD OF THE DISCLOSURE

The present disclosure relates to automated fishing rod holder assemblies and related methods of use and, more particularly, to fishing rod holder assemblies having an actuator device (e.g., electronically powered actuator device) configured to drill a releasably mounted auger member into a desired surface (e.g., sand/soil) to allow such rod holder assemblies to be easily mounted to the surface and later removed from the surface.

### BACKGROUND OF THE DISCLOSURE

In general, fishing rod holder assemblies are known. Conventional fishing rod holder assemblies can make it difficult and/or inconvenient to position/mount such assemblies into a desired surface (e.g., beach sand, soil, etc.).

As such, a need exists to develop fishing rod holder assemblies that are convenient and/or include improved features/structures.

Thus, an interest exists for improved fishing rod holder assemblies, and related methods of use. These and other inefficiencies and opportunities for improvement are addressed and/or overcome by the assemblies, systems and methods of the present disclosure.

### SUMMARY OF THE DISCLOSURE

The present disclosure provides advantageous automated fishing rod holder assemblies, and related methods of use. More particularly, the present disclosure provides advantageous fishing rod holder assemblies having an actuator device configured to drill a releasably mounted auger member into a desired surface (e.g., sand/soil) to allow such rod holder assemblies to be easily mounted to the surface and later removed from the surface.

In exemplary embodiments, the present disclosure provides for a fishing rod holder assembly including a housing extending from a first end to a second end, with an actuator device mounted with respect to the second end of the housing. An auger member can be releasably mounted to the actuator device, with the actuator device configured to drill the auger member into a desired surface (e.g., beach sand) to allow the rod holder assembly to be easily fixed/mounted in a substantially upright position relative to the surface, and then later easily removed from the surface when desired.

The present disclosure provides for a fishing rod holder assembly including a housing extending from a first end to a second end, the first end including an opening to a cavity that is configured and dimensioned to house a distal end of a fishing rod; an actuator device mounted with respect to the second end of the housing; an auger member releasably mounted with respect to the actuator device; wherein the actuator device is configured and dimensioned to drill the auger member into a desired surface to allow the housing to be easily mounted in a substantially upright position relative to the surface, and then later easily removed from the surface.

The present disclosure also provides for a fishing rod holder assembly wherein the housing is a substantially cylindrical elongated housing. The present disclosure also provides for a fishing rod holder assembly wherein the housing is fabricated from plastic. The present disclosure also provides for a fishing rod holder assembly wherein the actuator device is an electronically powered actuator device. The present disclosure also provides for a fishing rod holder assembly wherein the surface is sand or soil.

The present disclosure also provides for a fishing rod holder assembly wherein the actuator device is mounted at least partially within the second end of the housing. The present disclosure also provides for a fishing rod holder assembly wherein the cavity extends from the opening to a position along the length of the housing. The present disclosure also provides for a fishing rod holder assembly wherein a bottom end of the cavity includes a surface or other mounting feature for the distal end of the fishing rod.

The present disclosure also provides for a fishing rod holder assembly wherein the actuator device includes a receiver member that is configured and dimensioned to releasably mount with respect to a securing member of the auger member. The present disclosure also provides for a fishing rod holder assembly wherein the auger member extends from a first terminal end to a second terminal end, and includes a straight portion and a cork-screw portion.

The present disclosure also provides for a fishing rod holder assembly wherein the housing includes an on/off button for the actuator device. The present disclosure also provides for a fishing rod holder assembly wherein the housing includes a directional switch to control a drilling direction of the auger member.

The present disclosure also provides for a fishing rod holder assembly wherein a user can easily position the housing relative to the surface by drilling the auger member in a forward direction, and then easily remove the housing from the surface by operating the actuator device and auger member in a reverse direction.

The present disclosure also provides for a fishing rod holder assembly wherein the housing includes a charging port for the actuator device, and includes a cover member that covers the charging port to protect the charging port from salt water or other contamination.

The present disclosure also provides for a fishing rod holder assembly wherein the housing includes a first housing portion and a second housing portion, the actuator device at least partially disposed within the second housing portion.

The present disclosure also provides for a fishing rod holder assembly wherein the housing includes a first housing portion and a second housing portion, the actuator device at least partially disposed within the second housing portion; and wherein the second housing portion is mounted with respect to a cap member, the cap member configured to house at least a portion of the receiver member, and the cap member configured to house a sealed bearing member.

The present disclosure also provides for a fishing rod holder assembly including a substantially cylindrical elongated hollow housing extending from a first end to a second end, the first end including an opening to a cavity that is configured and dimensioned to house a distal end of a fishing rod, the cavity extending from the opening to a surface positioned along the length of the housing; an electronically powered actuator device mounted with respect to the second end of the housing; an auger member releasably mounted with respect to the actuator device; wherein the actuator device is configured and dimensioned to drill the auger member into a desired surface to allow the housing to be easily mounted in a substantially upright position relative to the surface, and then later easily removed from the surface; wherein the actuator device includes a receiver member that is configured and dimensioned to releasably mount with respect to a securing member of the auger member; wherein the auger member extends from a first terminal end to a second terminal end, and includes a straight portion and a cork-screw portion; and wherein a user can easily position the housing relative to the surface by drilling the auger member in a forward direction, and then easily remove the housing from the surface by operating the actuator device and auger member in a reverse direction.

The present disclosure also provides for a fishing rod holder assembly wherein the housing includes a first housing portion and a second housing portion, the actuator device at least partially disposed within the second housing portion. The present disclosure also provides for a fishing rod holder assembly wherein the second housing portion is mounted with respect to a cap member, the cap member configured to house at least a portion of the receiver member, and the cap member configured to house a sealed bearing member.

The present disclosure also provides for a method for mounting a fishing rod holder assembly including providing a housing extending from a first end to a second end, the first end including an opening to a cavity that is configured and dimensioned to house a distal end of a fishing rod; mounting an actuator device to the second end of the housing; releasably mounting an auger member to the actuator device; and operating the actuator device to drill the auger member into a desired surface to allow the housing to be easily mounted in a substantially upright position relative to the surface, and then later easily removed from the surface.

Any combination or permutation of embodiments is envisioned. Additional advantageous features, functions and applications of the disclosed assemblies, systems and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

Features and aspects of embodiments are described below with reference to the accompanying drawings, in which elements are not necessarily depicted to scale.

Exemplary embodiments of the present disclosure are further described with reference to the appended figures. It is to be noted that the various steps, features and combinations of steps/features described below and illustrated in the figures can be arranged and organized differently to result in embodiments which are still within the spirit and scope of the present disclosure. To assist those of ordinary skill in the art in making and using the disclosed systems, assemblies and methods, reference is made to the appended figures, wherein:

FIGS. 1-2 are front views of an exemplary fishing rod holder assembly according to the present disclosure;

FIG. 3 is a front view of the housing of the assembly of FIG. 1;

FIG. 4 is a front view of the auger member of the assembly of FIG. 1;

FIG. 5 is a front view of the second housing portion of the assembly of FIG. 1; and

FIG. 6 is a front view of the receiver member of the assembly of FIG. 1.

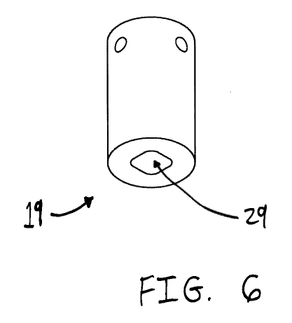

### DETAILED DESCRIPTION OF DISCLOSURE

The exemplary embodiments disclosed herein are illustrative of advantageous fishing rod holder assemblies, and systems of the present disclosure and methods/techniques thereof. It should be understood, however, that the disclosed embodiments are merely exemplary of the present disclosure, which may be embodied in various forms. Therefore, details disclosed herein with reference to exemplary fishing rod holder assemblies/fabrication methods and associated processes/techniques of assembly and use are not to be interpreted as limiting, but merely as the basis for teaching one skilled in the art how to make and use the advantageous fishing rod holder assemblies/systems and/or alternative fishing rod holder assemblies of the present disclosure.

The present disclosure provides advantageous automated fishing rod holder assemblies, and related methods of use. More particularly, the present disclosure provides improved fishing rod holder assemblies having an actuator device (e.g., electronically or gas powered actuator device) configured to drill a releasably mounted auger member into a desired surface (e.g., sand/soil) to allow such rod holder assemblies to be easily mounted to the surface and later removed from the surface.

In general, the present disclosure provides for a fishing rod holder assembly including a housing extending from a first end to a second end, with an actuator device mounted with respect to the second end of the housing. An auger member can be releasably mounted to the actuator device, with the actuator device configured to drill the auger member into a desired surface (e.g., beach sand) to allow the rod holder assembly to be easily fixed/mounted in a substantially upright position relative to the surface, and then later easily removed from the surface when desired.

Current practice provides that conventional fishing rod holder assemblies can make it difficult and/or inconvenient to position/mount such rod holder assemblies into a desired surface (e.g., beach sand, soil, etc.). In exemplary embodiments, the present disclosure provides for improved fishing rod holder assemblies having an actuator device configured to drill an auger member into a desired surface to allow such rod holder assemblies to be easily mounted to the surface and later easily removed from the surface, thereby providing a significant operational, commercial and/or manufacturing advantage as a result.

For example, an auger member can be releasably mounted to the actuator device, and the actuator device can be utilized to drill the auger member into a surface (e.g., beach sand) to allow the rod holder assembly to be easily fixed/mounted in a substantially upright position relative to the surface. A user can then house/mount a fishing rod with respect to the holder assembly while the holder assembly is in the substantially upright position (e.g., for fishing purposes). When desired, the user can thereafter easily remove the holder assembly from the surface (e.g., via the actuator device being operated in reverse).

Referring now to the drawings, like parts are marked throughout the specification and drawings with the same reference numerals, respectively. Drawing figures are not necessarily to scale and in certain views, parts may have been exaggerated for purposes of clarity.

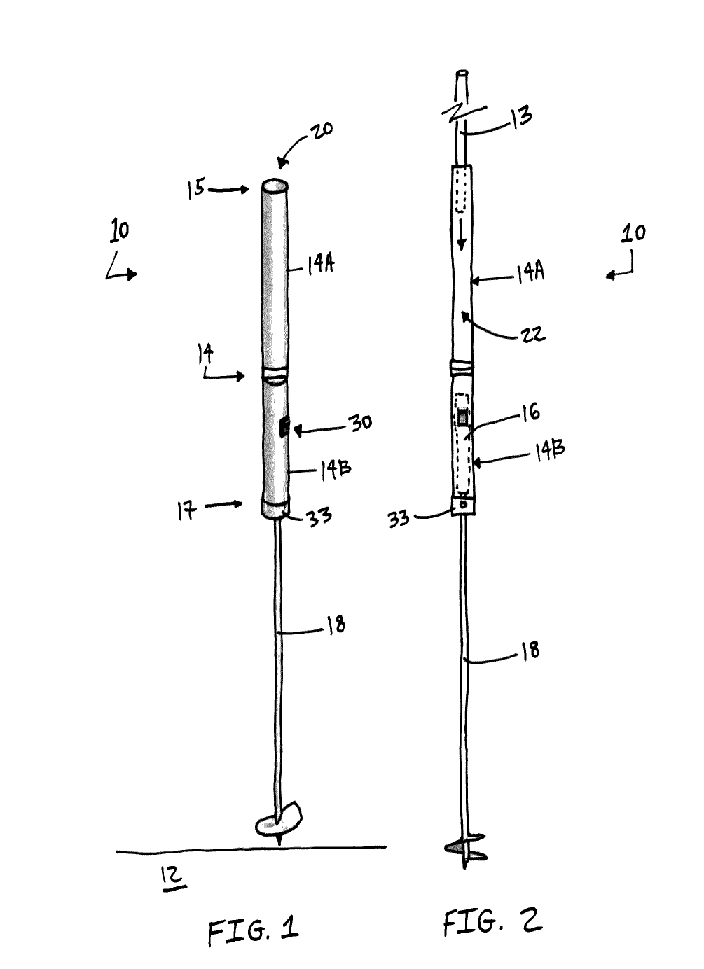

With reference to FIGS. 1-2, there is illustrated an exemplary embodiment of a fishing rod holder assembly 10 according to the present disclosure. In general, fishing rod holder assembly 10 is configured and dimensioned to be mounted in a substantially upright position relative to a surface 12 (e.g., sand/soil), and a user can then house/mount a fishing rod 13 with respect to the holder assembly 10 while the holder assembly 10 is in the substantially upright position (e.g., for fishing purposes).

Holder assembly 10 typically includes a housing 14 extending from a first end 15 to a second end 17. Exemplary housing 14 is elongated, hollow and substantially cylindrical, although the present disclosure is not limited thereto. Rather, housing 14 can take a variety of forms. In exemplary embodiments, housing 14 includes first housing portion 14A and second housing portion 14B.

In certain embodiments, housing 14 is plastic-based (e.g., PVC plastic-based), although the present disclosure is not limited thereto. Rather, it is noted that housing 14 can be fabricated from a variety of suitable materials and/or combination of materials (e.g., plastic, metal, etc.).

In exemplary embodiments, an actuator device 16 is mounted with respect to the housing 14 (e.g., mounted or disposed at least partially within second end 17 of second housing portion 14B of housing 14). In general, the actuator device 16 can be mounted with respect to the housing 14 utilizing a variety of fastening/mounting techniques and/or members.

Exemplary actuator device 16 is an electronically powered actuator device 16 or the like, although the present disclosure is not limited thereto. Rather, actuator device can take other suitable forms (e.g., gas powered actuator device 16 or the like).

An auger member 18 can be releasably mounted to the actuator device 16, with the actuator device 16 configured to drill the auger member 18 into a desired surface 12 (e.g., beach sand) to allow the housing 14 of rod holder assembly 10 to be easily fixed/mounted in a substantially upright position relative to the surface 12, and then later easily removed from the surface 12 when desired. As noted above, a user can then house/mount a fishing rod 13 with respect to the housing 14 of holder assembly 10 while the housing 14 is in the substantially upright position (e.g., for fishing purposes). Second end 17 of housing 14 can be positioned proximal or adjacent to surface 12 when assembly 10 is in the substantially upright position, or second end 17 can be positioned a distance away from surface 12 when assembly 10 is in the substantially upright position.

It is noted that the first end 15 of housing 14 typically includes an opening 20 to cavity 22 (e.g., hollow cavity) of housing 14. As shown in FIGS. 1-2, cavity 22 is configured and dimensioned to house/secure the distal or butt end of fishing rod 13 when the user houses/mounts fishing rod 13 with respect to the holder assembly 10 (e.g. while the holder assembly 10 is in the substantially upright position).

Cavity 22 typically extends from the opening 20 at first end 15 of housing 14 to a position along the length of housing 14 (e.g., exemplary cavity 22 extends about 16-18 inches). The bottom end 24 of cavity 22 typically includes a surface 27 or other mounting feature for the distal/butt end of rod 13 (e.g., a ring-shaped disk member 27 mounted to housing 14).

As noted, an auger member 18 can be releasably mounted to the actuator device 16, with the actuator device 16 configured to drill the auger member 18 into a desired surface 12. In exemplary embodiments, actuator device 16 includes or is mounted to a receiver member 19 (e.g., female receiver member or bit connector 19) that is configured and dimensioned (e.g., via opening 29) to releasably mount with respect to a securing member 21 (e.g., male securing bit 21) of auger member 18.

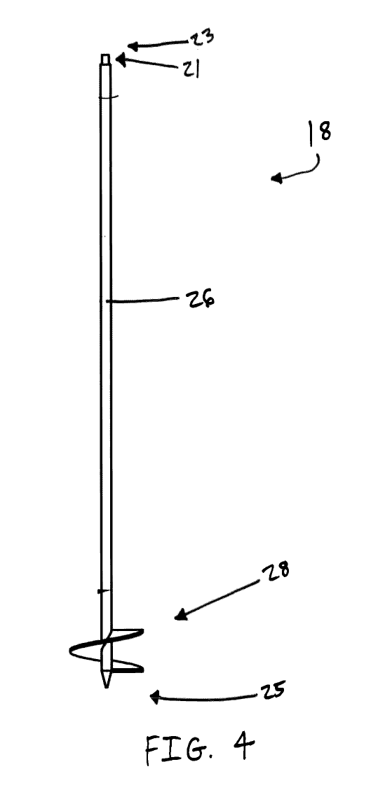

In some embodiments and as shown in FIG. 4, auger member 18 extends from a first terminal end 23 to a second terminal end 25, and includes a straight portion 26 and a cork-screw portion 28 (e.g., for drilling into surface 12). In certain embodiments, auger member 18 extends about 30 to 38 inches from end 23 to end 25, although the present disclosure is not limited thereto.

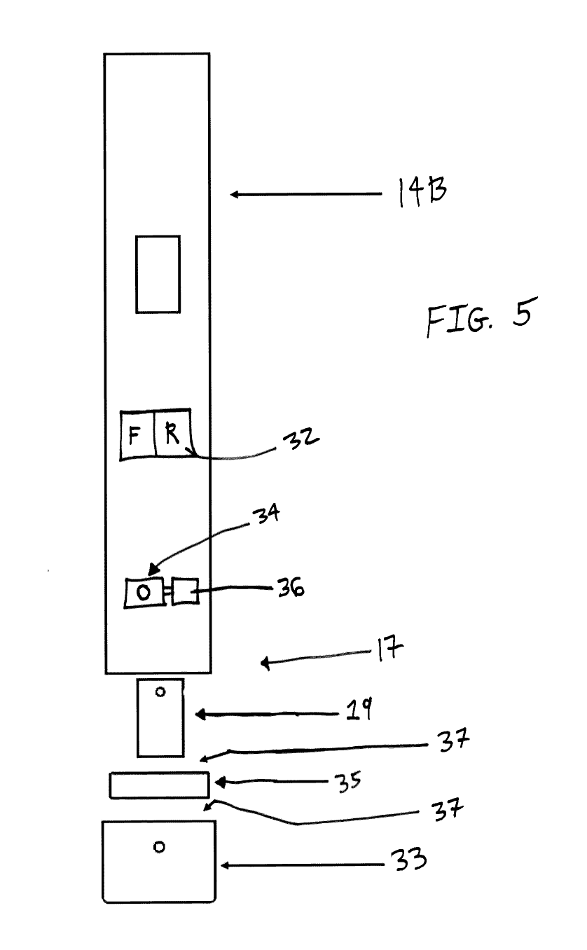

As shown in FIGS. 1 and 5, housing 14 (e.g., portion 14B) can include an on/off button 30 (e.g., rocker switch 30) for actuator device 18. Housing 14 can also include an optional directional switch/button 32 (FIG. 5) to control the drilling direction (forward or reverse drilling direction) of auger member 18 (e.g., via actuator device 16). As such, a user can easily position assembly 10 into surface 12 via drilling in the forward direction, and then easily remove assembly 10 from surface 12 by operating device 16 and member 18 in the reverse direction.

As shown in FIG. 5, housing 14 can also include an optional charging port 34 for actuator device 18, and an optional cover member 36 that covers ports 34 (e.g., to protect from salt water or other contamination or the like).

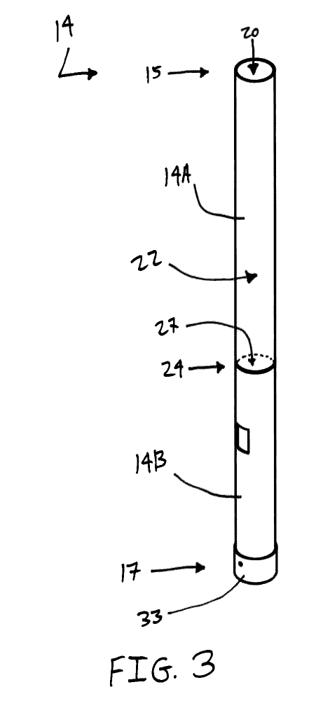

As shown in FIGS. 1-3 and 5, the second end 17 of housing 14 (e.g., end 17 of housing portion 14B) can be mounted with respect to a cap member 33 (e.g., substantially hollow cap member 33). In general, cap member 33 is configured to house at least a portion of receiver member 19, and can include/house a sealed bearing member 35. As shown in FIG. 5, sealant material 37 (e.g., marine silicon sealant material 37) can be positioned on bearing member 35 and/or within or on cap member 33, for waterproofing purposes.

Whereas the disclosure has been described principally in connection with fishing rod holder assemblies for recreational, commercial, industrial and/or domestic (e.g., fishing) purposes, such description has been utilized only for purposes of disclosure and is not intended as limiting the disclosure. To the contrary, it is to be recognized that the disclosed holder assemblies are capable of use for other retaining, holding, mounting and/or useful purposes (e.g., for retaining/holding other various items, materials and/or rods for a variety of purposes/uses, etc.).

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A fishing rod holder assembly comprising:
a housing extending from a first end to a second end, the first end including an opening to a cavity that is configured and dimensioned to house a distal end of a fishing rod;
an actuator device mounted with respect to the second end of the housing;
an auger member releasably mounted with respect to the actuator device;
wherein the actuator device is configured and dimensioned to drill the auger member into a desired surface to allow the housing to be easily mounted in a substantially upright position relative to the surface, and then later easily removed from the surface.

2. The fishing rod holder assembly of claim 1, wherein the housing is a substantially cylindrical elongated housing.

3. The fishing rod holder assembly of claim 1, wherein the housing is fabricated from plastic.

4. The fishing rod holder assembly of claim 1, wherein the actuator device is an electronically powered actuator device.

5. The fishing rod holder assembly of claim 1, wherein the surface is sand or soil.

6. The fishing rod holder assembly of claim 1, wherein the actuator device is mounted at least partially within the second end of the housing.

7. The fishing rod holder assembly of claim 1, wherein the cavity extends from the opening to a position along the length of the housing.

8. The fishing rod holder assembly of claim 1, wherein a bottom end of the cavity includes a surface or other mounting feature for the distal end of the fishing rod.

9. The fishing rod holder assembly of claim 1, wherein the actuator device includes a receiver member that is configured and dimensioned to releasably mount with respect to a securing member of the auger member.

10. The fishing rod holder assembly of claim 1, wherein the auger member extends from a first terminal end to a second terminal end, and includes a straight portion and a cork-screw portion.

11. The fishing rod holder assembly of claim 1, wherein the housing includes an on/off button for the actuator device.

12. The fishing rod holder assembly of claim 1, wherein the housing includes a directional switch to control a drilling direction of the auger member.

13. The fishing rod holder assembly of claim 1, wherein a user can easily position the housing relative to the surface by drilling the auger member in a forward direction, and then easily remove the housing from the surface by operating the actuator device and auger member in a reverse direction.

14. The fishing rod holder assembly of claim 1, wherein the housing includes a charging port for the actuator device, and includes a cover member that covers the charging port to protect the charging port from salt water or other contamination.

15. The fishing rod holder assembly of claim 1, wherein the housing includes a first housing portion and a second housing portion, the actuator device at least partially disposed within the second housing portion.

16. The fishing rod holder assembly of claim 9, wherein the housing includes a first housing portion and a second housing portion, the actuator device at least partially disposed within the second housing portion; and
wherein the second housing portion is mounted with respect to a cap member, the cap member configured to house at least a portion of the receiver member, and the cap member configured to house a sealed bearing member.

17. A fishing rod holder assembly comprising:
a substantially cylindrical elongated hollow housing extending from a first end to a second end, the first end including an opening to a cavity that is configured and dimensioned to house a distal end of a fishing rod, the cavity extending from the opening to a surface positioned along the length of the housing;
an electronically powered actuator device mounted with respect to the second end of the housing;
an auger member releasably mounted with respect to the actuator device;
wherein the actuator device is configured and dimensioned to drill the auger member into a desired surface to allow the housing to be easily mounted in a substantially upright position relative to the surface, and then later easily removed from the surface;
wherein the actuator device includes a receiver member that is configured and dimensioned to releasably mount with respect to a securing member of the auger member;
wherein the auger member extends from a first terminal end to a second terminal end, and includes a straight portion and a cork-screw portion; and
wherein a user can easily position the housing relative to the surface by drilling the auger member in a forward direction, and then easily remove the housing from the surface by operating the actuator device and auger member in a reverse direction.

18. The fishing rod holder assembly of claim 17, wherein the housing includes a first housing portion and a second housing portion, the actuator device at least partially disposed within the second housing portion.

19. The fishing rod holder assembly of claim 18, wherein the second housing portion is mounted with respect to a cap member, the cap member configured to house at least a portion of the receiver member, and the cap member configured to house a sealed bearing member.

20. A method for mounting a fishing rod holder assembly comprising:
providing a housing extending from a first end to a second end, the first end including an opening to a cavity that is configured and dimensioned to house a distal end of a fishing rod;
mounting an actuator device to the second end of the housing;
releasably mounting an auger member to the actuator device;
operating the actuator device to drill the auger member into a desired surface to allow the housing to be easily mounted in a substantially upright position relative to the surface, and then later easily removed from the surface.
